(19) United States
(12) Patent Application Publication
(10) Pub. No.: US 2022/0390571 A1
(43) Pub. Date: Dec. 8, 2022

(54) OBJECT DETECTION APPARATUS, RECEIVING UNIT AND CONTROL METHOD OF OBJECT DETECTION APPARATUS

(71) Applicant: DENSO CORPORATION, Kariya-city (JP)

(72) Inventors: Mariko SETO, Kariya-city (JP); Kenichi YANAI, Kariya-city (JP); Mitsuhiro KIYONO, Kariya-city (JP); Noriyuki OZAKI, Kariya-city (JP)

(21) Appl. No.: 17/820,513

(22) Filed: Aug. 17, 2022

Related U.S. Application Data
(63) Continuation of application No. PCT/JP2021/002052, filed on Jan. 21, 2021.

(30) Foreign Application Priority Data
Feb. 18, 2020 (JP) 2020-024823

(51) Int. Cl. G01S 7/481; G01S 17/10; G01S 17/89; G01S 17/931

(52) U.S. Cl. CPC G01S 7/4817; G01S 17/10; G01S 17/89; G01S 17/931

(57) ABSTRACT

An object detection apparatus that scans a detection range to detect an object is provided. The object detection apparatus includes a light emission unit that emits a pulse detection light; and a light reception unit having a plurality of light reception pixel groups, in which the plurality of light reception pixel groups include a reflected light reception pixel group that receives, at each scanning unit in a scanning operation, reflected light in response to an emission of the pulse detection light, and one or more visible light reception pixel groups corresponding to visible light components, receiving a visible light at each scanning unit in a scanning operation.

### CROSS REFERENCE TO RELATED APPLICATION

This application is the U.S. bypass application of International Application No. PCT/JP2021/002052 filed on Jan. 21, 2021, which designated the U.S. and claims priority to Japanese Patent Application No. 2020-024823, filed Feb. 18, 2020, the contents of both of these are incorporated herein by reference.

### BACKGROUND

### Technical Field

The present disclosure relates to an object detection technique utilized in the vehicle.

### Description of the Related Art

As a solid-state imaging device of a ranging apparatus for measuring a distance up to the object using the reflected light, a solid-state imaging device is proposed in which a pixel unit is provided as an imaging unit where IR pixels and RGB pixels are arranged. In general, the ranging image is acquired using IR pixels and the visible light image is acquired using RGB pixels.

### SUMMARY

The present disclosure can be embodied with the following aspects.

As a first aspect, an object detection apparatus that scans a detection range to detect an object is provided. The object detection apparatus of the first aspect includes: a light emission unit that emits a pulse detection light; and a light reception unit having a plurality of light reception pixel groups. The plurality of light reception pixel groups include a reflected light reception pixel group that receives, at each scanning unit in a scanning operation, reflected light in response to an emission of the pulse detection light, and one or more visible light reception pixel groups corresponding to visible light components, receiving a visible light at each scanning unit in a scanning operation.

### BRIEF DESCRIPTION OF THE DRAWINGS

The above-described object, and other objects, features, or beneficial advantages in this disclosure will be apparent from the appended drawings or the following detailed discussion.

In the accompanying drawings:

FIG. 1 is an explanatory diagram showing an example of a vehicle on which an object detection apparatus according to a first embodiment is mounted;

FIG. 2 is an explanatory diagram showing an overall configuration of LIDAR used for the first embodiment;

FIG. 3 is an explanatory diagram schematically showing a light reception element array used for the first embodiment;

FIG. 4 is an explanatory diagram schematically showing a filter arrangement in the light reception element array used for the first embodiment;

FIG. 5 is an explanatory diagram schematically showing another example of the filter arrangement in the light reception element array used for the first embodiment;

FIG. 6 is a block diagram showing a functional configuration of an object detection apparatus according to the first embodiment;

FIG. 7 is a flowchart showing a process flow of an object detection process executed by the object detection apparatus according to the first embodiment;

FIG. 8 is an explanatory diagram schematically showing a relationship between the light reception element array and a scanning position;

FIG. 9 is an explanatory diagram schematically showing a relationship between respective color component data acquired by the object detection apparatus, an acquiring timing and the scanning position

FIG. 10 is an explanatory diagram schematically showing a light reception element array used for other embodiments; and

FIG. 11 is an explanatory diagram schematically showing a sensitivity of the respective color components.

### DETAILED DESCRIPTION OF THE PREFERRED EMBODIMENTS

As a solid-state imaging device of a ranging apparatus for measuring a distance up to the object using the reflected light, JP-A-2019-114728 discloses a solid-state imaging device in which a pixel unit as an imaging unit where IR pixels and RGB pixels are arranged. In general, the ranging image is acquired using IR pixels and the visible light image is acquired using RGB pixels.

However, according to the conventional technique, since the RGB pixels are required to be provided in the pixel unit where IR pixels are occupied, an area for arranging the IR pixels becomes smaller, which degrades the ranging performance.

Therefore, it is required to acquire the ranging image and the visual light image without degrading the ranging performance.

Hereinafter, an objection detection apparatus, a light reception unit and a control method of the object detection apparatus according to the present embodiment will be descried with some of embodiments.

### First Embodiment

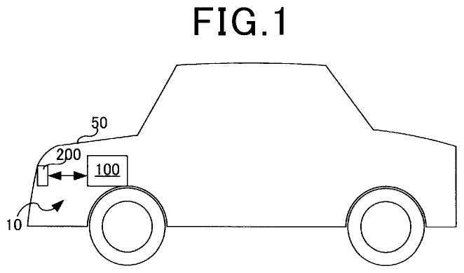

As shown in FIG. 1, an object detection apparatus 10 of a vehicle according to a first embodiment is used being mounted on a vehicle 50. The object detection apparatus 10 is provided with a LIDAR (i.e. Light Detection and Ranging) 200 and a control apparatus 100 that controls the operation of the LIDAR 200. The object detection apparatus 10 is also referred to as a ranging apparatus capable of detecting a location of the object and characteristics thereof in addition to a distance to an object. Other than this, the vehicle 50 may be provided with a camera 48 capable of acquiring RGB image data and a driving support control apparatus for performing the driving support.

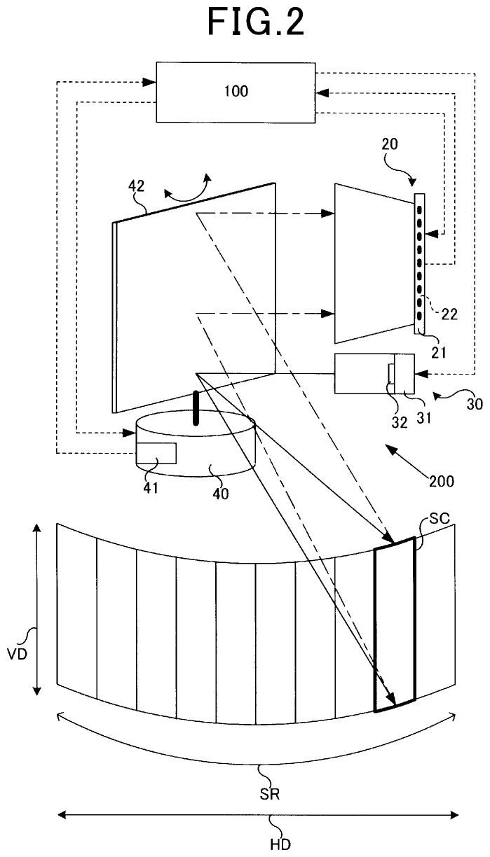

As shown in FIG. 2, the object detection apparatus 10 is provided with a LIDAR 200 and a control apparatus 100 that controls a light-emission operation and a light-reception operation of the LIDAR 200. The LIDAR 200 is configured as a light measuring unit that emits pulse detection light and receives a detection reflected light as a reflected light being incident depending on the emission of pulse detection light or an environmental light which is different from the detection reflected light. The LIDAR 200 and the control apparatus 100 may be physically integrated with a housing and accommodated therein or may be accommodated in separated housings. The LIDAR 200 is provided with a light reception unit 20, a light emission unit 30, a motor 40, a rotational angle sensor 41 and a scanning mirror 42. The LIDAR 200 has a scanning angle range SR which is pre-determined in the horizontal direction HD. The LIDAR 200 performs radiation of the detection light using the light emission unit 30 and a reception of the detection reflected light using the light reception unit 20 at a scanning angle unit SC where the scanning angle range SR is divided into a plurality of angles, whereby the detection reflected points are acquired through the entire scanning angle range SR to achieve the ranging. The scanning angle unit SC defines the resolution of the LIDAR 200 in the horizontal direction HD or the resolution of the ranging result acquired by the LIDAR 200 such that the smaller the scanning angle unit, that is, the larger the number of detection reflected points, the higher the resolution of the LIDAR 200 or the resolution of the ranging result. The acquisition of the detection points with the scanning angle unit range SC in the LIDAR 200, that is, the emission and light reception processes are executed while scanning the scanning angle range SR in one direction or reciprocatingly scanning the scanning angle range SR in both directions.

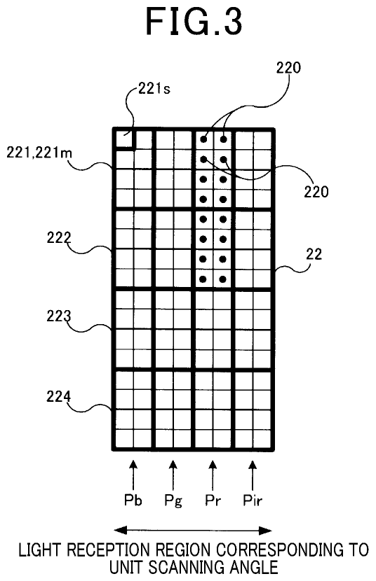

The light reception unit 20 is provided with a light reception element array 22 having a plurality of light reception pixel groups. The light reception unit 20 is further provided with a light reception control unit 21 and a light reception lens which is not shown. The light reception unit 20 executes a light reception process that outputs a detection signal indicating the detection points in response to the light reception of the detection reflected light corresponding to the detection light emitted from the light emission unit 30 and a light reception process that outputs environmental light image data which is also referred to as background light image data in response to the reception of the environmental light being incident regardless of the emission from the light emission unit 30. The environmental light includes ambient light which is not the detection light from the emission unit 30 but the light in the ambience caused by the sun light or an illumination light, the reflected light or scattered light from an object around the object detection apparatus 10 to which the sunlight or the illumination light are radiated. A RGB light can be obtained from these lights using a RGB filter. As shown in FIG. 3, the light reception element array 22 is an optical sensor having a plate shape in which a plurality of light reception elements 220 are arranged in the vertical and horizontal direction. Each light reception element is configured of, for example, a single photon avalanche diode (SPAD) and other photo diodes. Note that, as a minimum unit of the light reception process, that is, a light reception unit corresponding to a detection point, a term used for light reception pixel may be used. The light reception unit refers to either a light reception unit 221 composed of a single light reception element or a light reception pixel 221 composed of a plurality of light reception elements. In the light reception element array 22, the smaller the number of light reception elements which compose the light reception pixel (i.e. light reception unit), the larger the number of light reception unit, that is, the number of detection points. According to the present embodiment, for example, with a light reception pixel 222 composed of eight light reception elements 220 as a light reception unit, a first light reception pixel 221, a second light reception pixel 222, a third light reception pixel 223 and a fourth light reception pixel 224 are arranged from the upper stage in the vertical direction of the scanning angle range SR.

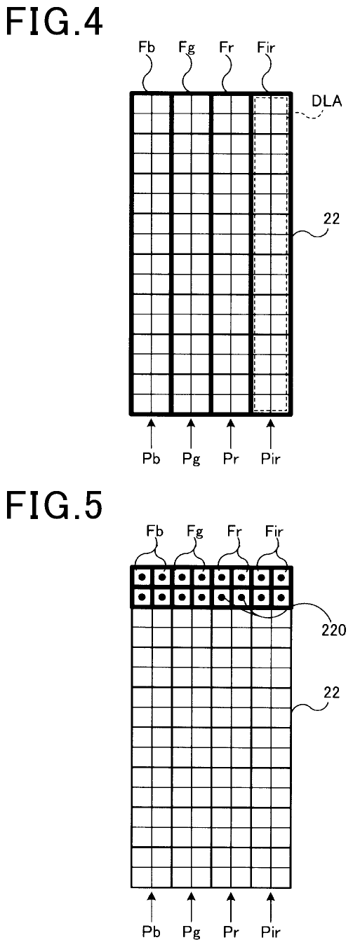

According to the present embodiment, the light reception element array 22 is provided with, with a light reception region corresponding to the scanning angle unit SC, a reflected light reception pixel group Pir that receives reflected light in response to the emission of the detection light and a visible light reception pixel group Pr, Pg, Pb that receives the visible light. The reflected light reception pixel group Pir and the visible light reception pixel group Pr, Pg, Pb may preferably be a column group being arranged adjacently in a direction corresponding to the scanning direction, so as to continuously acquire the reflected light and the visible light depending on the scanning angle unit, and a plurality of visible light reception pixel groups Pr, Pg, Pb may preferably be arranged in a direction corresponding to the scanning direction. Further, a reflected light reception pixel group Pir that receives the reflected light used for the ranging may preferably be arranged at the center of the light reception element array 22 corresponding to the detection axis of the object detection apparatus 10 so as to secure the detection accuracy. Further, the light reception area of the reflected light reception pixel group Pir that receives IR light which the sensitivity is low, is larger than that of the visible light reception pixel group Pr, Pg, Pb. As shown in FIG. 4, in the reflected light reception pixel group Pir, an IR transmission filter Fir that allows only infrared light to transmit therethrough is provided. The light reception unit 20 is designed such that the IR reflected light reflected at an object in response to the IR pulse detection light emitted from the light emission unit 30 is incident on a reflected light reception region DLA in the light reception element 22. The IR reflected light is received by the reflected light reception pixel group Pir. In the visible light reception pixel group Pr, Pg and Pb, a R transmission filter Fr, a G transmission filter Fg, a B transmission filter Fb are arranged allowing a red light, a green light and a blue light to pass through respectively. The visible light reception pixel group Pr, Pg and Pb receives the environmental light at a timing different from the emission timing of the detection light by the light emission unit 30 or the same timing as the emission timing of the detection light by the light emission unit 30. As a result, the light reception unit 20 sequentially receives the reflected light and the environmental light, that is, infrared light, red light, green light and blue light at different timings or at the same timing during a time window corresponding to the scanning angle unit SC. In an example shown in FIG. 4, respective filters Fir, Fr, Fg and Fb are attached to the respective light reception pixel group Pir, Pr, Pg and Pb. However, as shown in FIG. 5, the filters Fir, Fr, Fg and Fb may be arranged corresponding to respective light reception elements 229 composing respective light reception pixel group Pir, Pr, Pg and Pb. In this case, existing light reception element array can be used. Hence, versatility can be more enhanced.

The light reception control unit 21 executes, in response to the emission of the pulse detection light from the light emission unit 30, a light reception process that outputs an incident light intensity signal depending on an incident light quantity or an incident light intensity for respective light reception pixel group Pir, Pr, Pg and Pb. Specifically, the light reception control unit 21 utilizes whole light reception pixels 221 to 224 to detect, for each scanning angle unit SC, current generated by the light reception elements constituting the light reception elements 221 to 224 depending on the incident light quantity, or voltage converted from the detected current. The light reception control unit outputs the detected current and voltage converted from the detected current as the incident light intensity signal to the control apparatus 100. The incident light intensity signal may be outputted to the control apparatus 100 for each scanning angle unit SC or an incident light intensity signal corresponding to the scanning angle range SR at a time when the scanning for the scanning angle range SR is completed, may be outputted to the control apparatus 100. Note that, an incident light intensity signal depending on the total number of photon detected by the light reception element constituting the respective light reception pixels 221 to 224 can be outputted the control apparatus 100. Generally, according to the SPAD, since the incident light quantity acquired by a single light reception element 220 is small, the incident light intensity signal of eight light reception elements 220 included in such as the light reception pixel 221 are summed to enhance the S/N ratio. A ranging functional unit that executes a ranging for the detection points using TOF (time of flight) method, may be provided being integrated as a circuit of the light reception control apparatus 21, or may be provided as a program executed by the control apparatus 100 which will be described later.

The light emission unit 30 is provided with a light emission control unit 31, a light emission element 32 and a collimator lens. The light emission unit 30 emits detection light at the scanning angle unit SC for a single time or a plurality times discretely. The emission unit 32 is configured as, for example, one or more infrared laser diodes and emits pulse infrared laser light as the detection light. The emission unit 30 may be provided with a single emission element or a plurality of emission elements in the vertical direction. When the plurality of emission elements are provided, the light emission control unit 31 may switch the emission elements which emit depending on the scanning timing. The light emission control unit 31 receives an emission control signal transmitted from the control apparatus 100 at the scanning angle unit, commanding the light emission element to emit, and drives, in response to the received emission control signal, the light emission elements with a drive signal having pulse driving waves to execute an emission of the infrared laser light. The infrared laser light emitted from the light emission unit 30 is reflected at the scanning mirror 42 and radiated towards outside the LIDAR 200, that is, towards a desired range for detecting an object.

The motor 40 is provided with a motor driver which is not shown. The motor 40 is provided with a rotation sensor 41 that detects the rotational angle of the motor 40. The motor driver receives a rotational angle command signal outputted from the control apparatus 100 in response to the rotational angle signal transmitted from the rotational angle sensor 41, and changes the voltage applied to the motor 40 based on the rotational angle command signal to control the rotational angle of the motor 40. The motor 40 is configured as, for example, an ultrasonic motor, a brushless motor or a brush motor and provided with an known mechanism that performs a reciprocating movement in the scanning angle range SR. The scanning mirror 42 is attached to the tip end portion of the output shaft of the motor 40. The scanning mirror 42 serves as a reflector for scanning the detection light emitted from the light emission element 32 in the horizontal direction HD, that is a mirror. When the motor 40 drives the scanning mirror 42 reciprocatingly, whereby the scanning in the scanning angle range SR in the horizontal direction HD is accomplished. Note that one reciprocating scanning by the scanning mirror is referred to as one frame, which is a detection unit of the LIDAR 200. The light emission unit 30 may emit the detection light corresponding to a deviation in the reciprocating operation of the scanning mirror 42 in one direction or corresponding to a deviation in the reciprocating operation of the scanning mirror 42 in the both directions. In other words, an object detection of the LIDAR 200 can be executed in one direction or the both directions of the scanning angle range SR. Moreover, the scanning may be performed in the vertical direction VD in addition to the horizontal direction HD, that is, the scanning position in the vertical direction VD may be changed. In order to perform the scanning in the horizontal direction HD and in the vertical direction VD, the scanning mirror 42 may be a polygonal mirror or a single plane mirror provided with a mechanism capable of moving in the vertical direction VD or another single plane mirror capable of moving in the vertical direction VD. Note that the scanning mirror 42 may be rotatably driven by the motor 40 to perform a rotational scanning. In this case, the light emission unit 30 and the light reception unit 20 may execute the light emission process and the light reception process for the scanning angle range SR. Further, for example, when the scanning angle range SR having approximately 60 degrees can be set, a light reception element array having a lateral width corresponding to the scanning angle range SR may be provided without the scanning mirror 42 and may detect an object by sequentially selecting the column and the row, that is, may execute the ranging process.

The detection light emitted from the light emission unit 30 is reflected at the scanning mirror 42 and scans the scanning angle range SR in the horizontal direction with the scanning angle unit SC as a scanning unit. The detection reflected light, in which the detection light is reflected at an object, proceeds to the light reception unit 20 by being reflected at the scanning mirror 42 and is incident at the light reception unit 20 at each scanning angle unit SC. The light reception unit 20 executes the light reception process for each column at the light emission timing of the light emission unit 30. The scanning angle unit SC with which the light reception process is executed, is subsequently incremented. As a result, the scanning can be performed for the light reception process through the desired scanning angle range SR. The light emission unit 30 and the light reception unit 20 may be rotated together with the scanning mirror 42 by the motor 40 or may be separated from the scanning mirror 42 without being rotated by the motor 40. Further, without the scanning mirror 42, a plurality of light reception pixels or a light reception array 22 may be provided corresponding to the scanning angle range SR such that laser beam is directly and sequentially radiated towards outside and the reflected light is directly received by sequentially switching the light reception pixels.

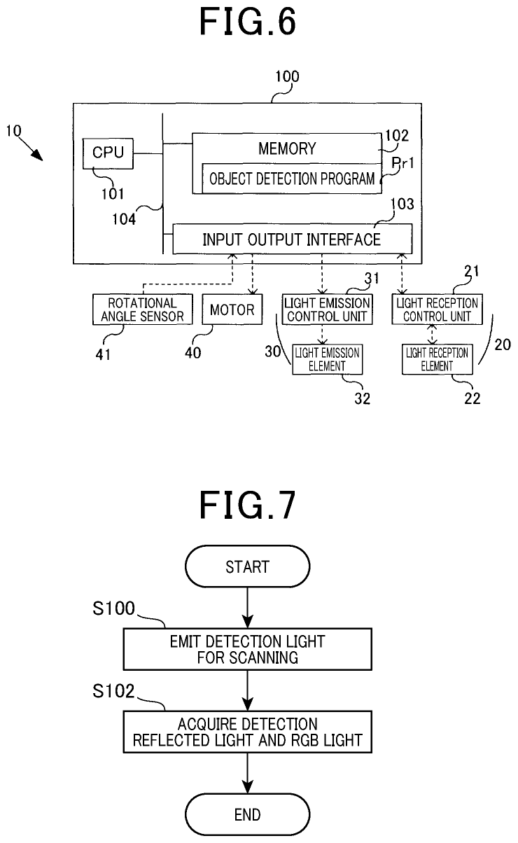

As shown in FIG. 6, the control apparatus 100 is provided with a central processing unit (CPU) 101 as an arithmetic unit, a memory 102 as a storage unit, an input-output interface 103 as an input-output unit and a clock generator which is not shown. The CPU 101, the memory 102, the input-output interface 103 and the clock generator are connected to be bidirectionally communicable via the internal bus 104. The memory 102 includes a non-volatile read only memory (e.g. ROM) where an object detection processing program Pr1 for executing an object detection process is stored therein, and a memory which is readable and writeable by the CPU 101 (e.g. RAM). The CPU 101 as the control apparatus 100 loads the object detection processing program Pr1 stored in the memory 102 into the readable/writable memory and executes the object detection processing program Pr1, whereby the control apparatus 100 serves as an object detection unit. The CPU 101 may be configured as a single CPU or a plurality of CPUs that execute respective programs, or may be configured as a multi-task type or a multi-thread type CPU capable of simultaneously executing a plurality of programs. The ranging process for measuring distance up to an object using the light emission timing and the light reception timing may be executed by the control apparatus 100 as a process of the object detection process other than being executed by the light reception control unit 21.

The light reception control unit 21 that constitutes the light reception unit 20, the light emission control unit 31 that constitutes the light emission unit 30, the motor 40 and the rotational angle sensor 41 are each connected to the input-output interface 103 via a control signal line. For the light emission control unit 31, a light emission control signal is transmitted thereto. For the light reception control unit 21, a light reception control signal is transmitted thereto, commanding a light reception process to execute for acquiring the environmental light or a light reception process to execute for detecting an object corresponding to a transmitted light emission control signal. The control apparatus 100 receives, from the light reception control unit 21, the incident light intensity signal indicating the environmental light intensity or the detection reflected light intensity. Moreover, a rotational angle command signal is transmitted to the motor 40, and the control apparatus 100 receives a rotational angle signal from the rotational angle sensor 41.

An object detection process including acquisition of the environmental light intensity executed by the object detection apparatus 10 according to the first embodiment will be described. A processing routine shown in FIG. 7 is repeatedly executed during a period from the start timing to the end timing of the vehicle control system at a predetermined interval, for example, several hundreds msec. The process flow shown in FIG. 7 is executed by the CPU 101 when executing the object detection processing program Pr1.

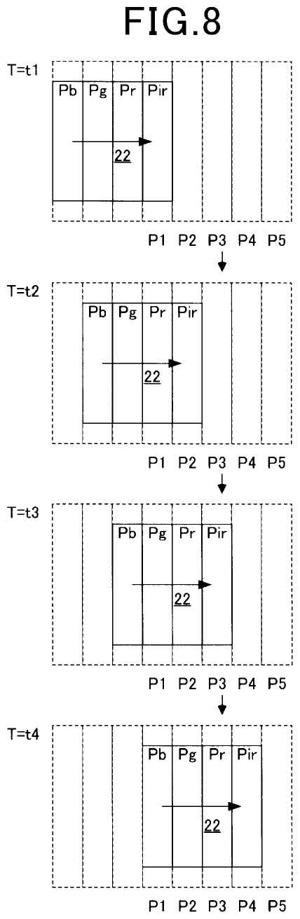

The CPU 101 transmits a light emission command signal to the light emission control unit 31 via the input-output interface 103, thereby making the light emission element 32 emit to radiate the detection light (step S100). The CPU 101 transmits the light reception command signal to the light reception control unit 21 to acquire the detection reflected light and the RGB light by the light reception element array 22, and terminates the processing routine. The detection reflected light is received by the existing reflected light reception pixel group Pir, and the RGB light contained in the incident light as the incident environmental light is received by the existing visible light reception pixel group Pr, Pg, Pb. Since the respective light reception pixel group Pir, Pr, Pg and Pb are arranged at different positions in the horizontal direction, the incident light acquired at the same timing by the respective light reception pixel group Pir, Pr, Pg and Pb differ between different positions. For example, as shown in FIG. 8, when the light reception time T advances from t1 to t4, that is, accompanying with the scanning by the scanning mirror 42, the incident light from the position P1 subsequently enters the reflected light reception pixel group Pir, the visible light reception pixel group Pr, the visible light reception pixel group Pg and the visible light reception pixel group Pg included in the light reception element array 22. At time T=t1, the incident light reflected at the position P1 in response to the detection light enters the reflected light reception pixel group Pir. At time T=t2, the incident light from the position P1 enters the visible light reception pixel group Pr and the incident light reflected at the position P2 in response to the detection light enters the reflected light reception pixel group Pir. At time T=t3, the incident light from the positions P1 and P2 enters the visible light reception pixel group Pr and Pg respectively and the incident light reflected at the position P3 in response to the detection light enters the reflected light reception pixel group Pir. At time T=t4, the incident light from the positions P1 to P3 enters the visible light reception pixel group Pr, Pg, Pb respectively, and the incident light reflected at the position P4 in response to the detection light enters the reflected light reception pixel group Pir. In the example shown in FIG. 8, respective light reception time t1 to t4 are constant, and the light reception time T refers to a detection time which may be exchangeable with the scanning angle unit SC.

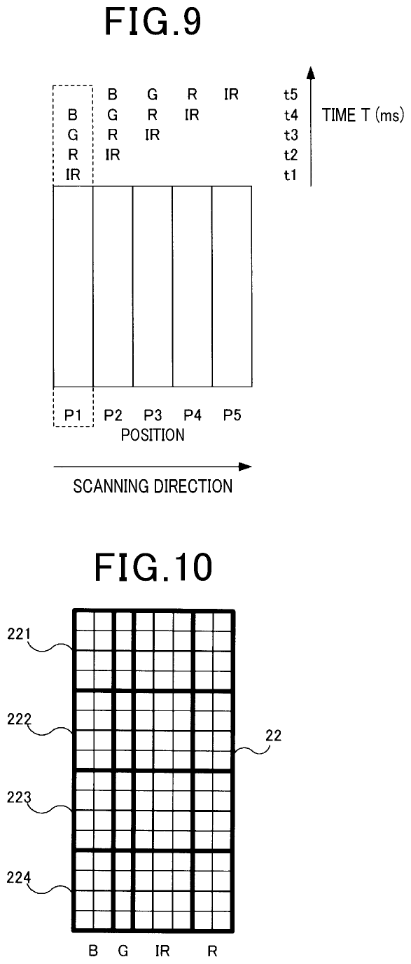

As a result, as shown in FIG. 9, an infrared reflection light IR, a red light R, a green light G and a blue light B are sequentially acquired through time t1 to t4. Specifically, information about the detection reflected light and the environmental light in the same position or in the same space, for example, the detection data indicating the intensity can be acquired. Note that, since the time interval between respective light reception time T is msec order, information about the detection reflected light and the environmental light is acquired in which sufficient accuracy can be secured at a substantially the same timing or in the latter process.

According to the object detection apparatus 10 of the first embodiment as described above, the light reception unit 20 is provided with a plurality of light reception pixel groups including the reflected light reception pixel group Pir that receives the reflected light in response to an emission of the pulse detection light, and one or more visible light reception pixel groups Pr, Pg and Pb corresponding to visible light components, receiving visible light, which receive corresponding light at each scanning unit in the scanning operation. Hence, the ranging image and the visible light image can be acquired without degrading the ranging performance. In other words, it is provided with the reflected light reception pixel group Pir that receives the reflected light corresponding to the scanning angle unit as a scanning unit in the scanning operation, and one or more visible light reception pixel group Pr, Pg and Pb corresponding to visible light components, receiving visible light. Also, the light reception pixel group is provided being allocated to respective color components. Therefore, the light reception sensitivity can be prevented from being reduced, or the light reception sensitivity can be enhanced. As a result, since the respective color components including the IR component are received for each scanning angle unit, the incident light intensity larger than or equal to the desired intensity can be obtained for respective color components, thereby improving the ranging accuracy or improving the accuracy for recognizing the object. Therefore, an accuracy for a driving assist control using the distance and positions between the vehicle 50 and an object and an accuracy for an automatic driving control can be enhanced.

The light reception unit 20 included in the object detection apparatus 10 according to the above-described first embodiment is provided with the reflected light reception pixel group Pir that receives reflected light at each scanning angle unit and one or more visible light reception pixel group Pr, Pg, Pb corresponding to visible light components, receiving the visible light at each scanning angle unit. Hence, the reflected light, the red light, the green light and the blue light can be accurately acquired from the same position in the detection region of an object.

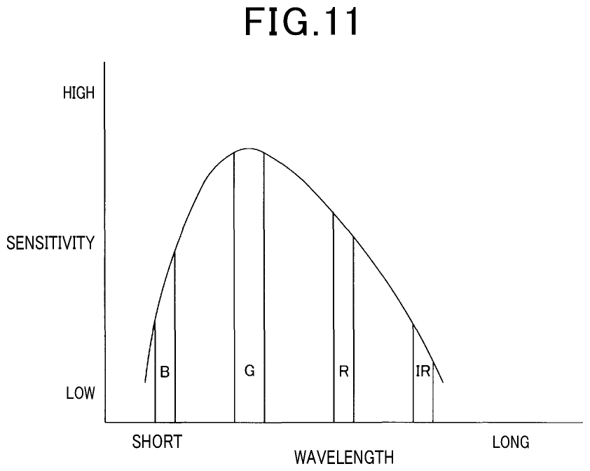

In the above description, the light reception element array 22 includes respective light reception pixel group Pir, Pr, Pg, Pb having the same area and the same number of light reception pixels 221. However, the light reception sensitivity of the light reception pixel 221 in the respective light reception pixel group Pir, Pr, Pg and Pb or the light reception sensitivity of the light reception element 220 that constitutes the light reception pixel 221 varies depending on the light wavelength. In this respect, in order to set equal sensitivity or optimized sensitivity for respective components in IR and RGB light, as shown in FIG. 10, different light reception area may be provided depending on the color components. As shown in FIG. 11, since the sensitivity for the G component is the highest among those in the RGB and IR components, even with smaller light reception area than the light reception area of other color components, the similar incident light intensity can be obtained. On the other hand, since the sensitivity for the IR component is the lowest among the RGB component and the IR component, the light reception area larger than those of other color components can be allocated, thereby obtaining similar incident light intensity. In an example shown in FIG. 10, the light reception area of the light reception pixel group Pg corresponding to G component is smaller than the light reception areas of the light reception pixel group Pr and Pb corresponding to the R component and B component, and the light reception area of the light reception pixel group Pir corresponding to IR component is larger than the light reception areas of the light reception pixel group Pr and Pb corresponding to the R component and B component. As a result, the light reception areas corresponding to the sensitivities of the respective color components are set, whereby the light reception pixels 221 that constitute the light reception element array 22 can be effectively utilized. The light reception area corresponding to the respective color components in the light reception element array 22 can be allocated by disusing some of the respective light reception pixel group Pir, Pr, Pg and Pb or changing the number of light reception pixels 221 that constitute the respective light reception pixels Pir, Pr, Pg and Pb or changing the number of light reception elements 220 that constitute the respective light reception pixels 221.

In the above description, the light reception time T, that is, the exposure time is constant. However, the exposure time for RGB component (i.e. visible light reception pixel group Pr, Pg, Pb) is variable. For example, in view of white balance, the exposure time of the visible light reception pixel group Pr that acquires red light component in the time around sunset can be shortened. Further, in the light reception element array 22, the exposure time for the reflected light reception pixel group Pir and the visible light reception pixel group Pr, Pg and Pb may be appropriately adjusted depending on the light reception sensitivity of the IR component and the respective RGB components.

In the above-description, the excess vias voltage applied to the SPAD used for the light reception element is constant. In contrast, the excess bias voltage may be changed to adjust the sensitivity of the SPAD. Specifically, the excess bias voltage may be changed to the light reception pixel 221 corresponding to the respective light reception pixel group Pir, Pr, Pg and Pb, depending on light reception sensitivity of the IR component and the RGB component. In other words, the excess bias voltage is set to be smaller in order to decrease the light reception sensitivity, and the excess bias voltage is set to be larger in order to increase the light reception sensitivity.

In the above-description, the filter transmissivity is not mentioned for the respective filters Fir, Fr, Fg and Fb. For example, these filter transmissivities may be the same. In contrast, each filer transmissivity may be set for respective filters Fir, Fr, Fg and Fb included in the light reception pixel group Pir, Pr, Pg and Pb, depending on the light reception sensitivity of the IR component and the RGB components. Specifically, when the light reception sensitivity is required to be lowered, the filter transmissivity is set to be lowered, and when the light reception sensitivity is required to be higher, the filter transmissivity is set to be higher. In the above-description, the light reception sensitivity is set depending on the IR component and the RGB component. However, the light reception sensitivity may be dynamically determined depending on a change in the actual detected incident light intensity relative to the reference incident light intensity in the light reception element array 22.

### OTHER EMBODIMENTS

(1) In the above-described embodiments, the object detection apparatus 10 provided with the light emission unit 30 is described. The technical effects obtained in the above-described embodiments can be also obtained with a light reception unit 20 as a minimum configuration used for an object detection apparatus 10 that scans a detection range. The light reception unit 20 is provided with a plurality of light reception pixel groups including a reflected light reception pixel group Pir that receives reflected light in response to the emission of the pulse detection light at each scanning unit in the scanning operation and a visible light reception pixel group Pr, Pg, Pb that receives the visible light at each scanning unit in the scanning operation.

(2) In the above-described embodiments, the light reception array 22 is provided with the visible light reception pixel group Pr, Pg and Pb corresponding to the RGB component. However, the light reception array 22 may be configured to receive the visible light corresponding to at least one of R component, G component and B component. In this case, the reflected light reception pixel group Pir and the visible light reception pixel group Pr constitute a column group arranged adjacently in a direction corresponding to the scanning direction. For example, only the visible light reception pixel group Pr that detects the red light may be provided. This is because, in the RGB components, the R component corresponds to the red light signal in the traffic signs, a brake light of the vehicle 50 or a red light of an emergency vehicle, and the vehicle 50 is required to perform a driving support or vehicle control as fast as possible. In this case, in order to suppress a shift in the light reception time, the reflected light reception pixel group Pir and the visible light reception pixel group Pr that receives the red light may preferably be adjacently positioned. According to the above-described embodiments, three visible light reception pixel group Pr, Pg, Pb are provided, but one or a plurality of visible light pixel group, where a filter adapted for a plurality of color components, that is, R component, G component and B component is provided for a single visible light reception pixel group, may be provided. In this case, a shift in the acquiring time for the reflected light, the respective color components of the red light, the greenlight and the blue light, especially the RGB component, which correspond to the same position can be cancelled. Further, according to the above-described embodiments, the reflected light reception pixel group Pir and the visible light reception pixel group Pr, Pg and Pb are arranged adjacently in the direction corresponding to the scanning direction, but they may not be arranged adjacently.

(3) In the above-described embodiments, the reflected light reception pixel group and the visible light reception pixel group are the provided in the same light reception element array 22. However, the reflected light reception pixel group and the visible light reception pixel group are provided in separated light reception arrays. Specifically, as a visible light reception pixel group, a general imaging device that acquires RGB image, for example, a CMOS (i.e. complementary metal oxide semiconductor) or a CCD (i.e. charge coupled device) imaging device may be utilized. Even in this case, the imaging device is provided in the object detection apparatus 10 so as to acquire images at the same position at each unit scanning angle together with the reflected light reception pixel group.

(4) In the above-described embodiments, the CPU 101 executes the object detection processing program Pr1, thereby achieving the object detection apparatus 10 that performs an object detection. However, the object detection apparatus 10 can be achieved by a hardware such as a pre-programmed integrated circuit or a discrete circuit. The control unit and method thereof disclosed in the above-described embodiments may be accomplished by a dedicated computer constituted of a processor and a memory programmed to execute one or more functions embodied by computer programs. Alternatively, the control unit and method thereof disclosed in the present disclosure may be accomplished by a dedicated computer provided by a processor configured of one or more dedicated hardware logic circuits. Further, the control unit and method thereof disclosed in the present disclosure may be accomplished by one or more dedicated computer where a processor and a memory programmed to execute one or more functions, and a processor configured of one or more hardware logic circuits are combined. Furthermore, the computer programs may be stored, as instruction codes executed by the computer, into a computer readable non-transitory tangible recording media.

The present disclosure has been described based on the embodiments and modification example. However, the embodiments of the above-described disclosure are to readily understand the present disclosure and does not limit the present disclosure. The present disclosure may be modified, improved without departing the sprit thereof and scope of claims and may include equivalents thereof. For example, embodiments corresponding to the technical features in the respective aspects described in the summary section and the technical features described in the modification examples may be appropriately replaced or combined to achieve a part of or all of the above-described effects. Further, the technical features thereof may be appropriately removed unless described as necessary in the specification.

### CONCLUSION

As a first aspect, an object detection apparatus that scans a detection range to detect an object is provided. The object detection apparatus of the first aspect includes: a light emission unit that emits a pulse detection light; and a light reception unit having a plurality of light reception pixel groups. The plurality of light reception pixel groups include a reflected light reception pixel group that receives, at each scanning unit in a scanning operation, reflected light in response to an emission of the pulse detection light, and one or more visible light reception pixel groups corresponding to visible light components, receiving a visible light at each scanning unit in a scanning operation.

According to the object detection apparatus of the first aspect, the ranging image and the visual light image can be acquired without degrading the ranging performance.

As a second aspect, a method for controlling an object detection apparatus that scans a detection range to detect an object is provided. The method for controlling an object detection apparatus includes steps of emitting pulse detection light to scan the detection range; receiving, at each scanning unit in a scanning operation, a reflected light in response to an emission of the pulse detection light, with a reflected light reception pixel group included in a light reception unit; and receiving, at each scanning unit in the scanning operation, a visible light, with one or more visible light reception pixel groups corresponding to visible light components included in the light reception unit.

According to the method for controlling the object detection apparatus of the second aspect, the ranging image and the visual light image can be acquired without degrading the ranging performance.

As a third aspect, a light reception unit used for an object detection apparatus that scans a detection range is provided. The light reception unit according to the third aspect includes a plurality of light reception pixel groups, in which the plurality of light reception pixel groups include a reflected light reception pixel group that receives, at each scanning unit in a scanning operation, reflected light in response to an emission of a pulse detection light, and one or more visible light reception pixel groups corresponding to visible light components, receiving a visible light at each scanning unit in the scanning operation.

According to the light reception unit of the third aspect, the ranging image and the visual light image can be acquired without degrading the ranging performance. Note that the present disclosure can be embodied with a control program of an object detection apparatus or a non-transitory tangible computer readable recording media that stores the control program.

What is claimed is:

1. An object detection apparatus that scans a detection range to detect an object, the object detection apparatus comprising:
a light emission unit that emits a pulse detection light; and
a light reception unit having a plurality of light reception pixel groups, wherein
the plurality of light reception pixel groups include a reflected light reception pixel group that receives, at each scanning unit in a scanning operation, reflected light in response to an emission of the pulse detection light, and one or more visible light reception pixel groups corresponding to visible light components, receiving a visible light at each scanning unit in a scanning operation.

2. The object detection apparatus according to claim 1, wherein
the plurality of visible light reception pixel groups are arranged in a direction corresponding to a scanning direction.

3. The object detection apparatus according to claim 1, wherein
the reflected light reception pixel groups and the visible light reception pixel groups are arranged adjacently to a direction corresponding to a scanning direction to form a column group; and
the light reception unit is configured to execute a light reception process of the reflected light reception pixel group and a light reception process of the visible light reception pixel group.

4. The object detection apparatus according to claim 1, wherein
the reflected light reception pixel groups and the visible light reception pixel groups have corresponding light reception area depending on a light reception sensitivity.

5. The object detection apparatus according to claim 1, wherein
the light reception unit is configured to control a light reception time of the reflected light reception pixel groups and the visible light reception pixel groups, depending on a light reception sensitivity.

6. The object detection apparatus according to claim 1, wherein
the light reception unit is configured to control a voltage applied to the reflected light reception pixel groups and the visible light reception pixel groups, depending on a light reception sensitivity.

7. The object detection apparatus according to claim 1, wherein
the visible light reception pixel groups receive at least one of visible light components of a R component, a G component and a B component.

8. The object detection apparatus according to claim 7, wherein
the visible light reception pixel groups receive the visible light component of the R component.

9. The object detection apparatus according to claim 1, wherein
the visible light reception pixel groups have filters on light reception pixels.

10. A method for controlling an object detection apparatus that scans a detection range to detect an object, the method comprising steps of:
emitting pulse detection light to scan the detection range;
receiving, at each scanning unit in a scanning operation, a reflected light in response to an emission of the pulse detection light, with a reflected light reception pixel group included in a light reception unit; and
receiving, at each scanning unit in the scanning operation, a visible light, with one or more visible light reception pixel groups corresponding to visible light components included in the light reception unit.
